(19) United States
(12) Patent Application Publication
(10) Pub. No.: US 2009/0025993 A1
(43) Pub. Date: Jan. 29, 2009

(54) VEHICLE HAVING AN AERODUCTING SYSTEM

(75) Inventor: Christian P. Hines, Hartland, MI (US)

Correspondence Address: DOBRUSIN & THENNISCH PC, 29 W LAWRENCE ST, SUITE 210, PONTIAC, MI, 48342, US

(73) Assignee: Merlyn LLC

(21) Appl. No.: 12/175,796

(22) Filed: Jul. 18, 2008

Related U.S. Application Data
(60) Provisional application No. 60/951,306, filed on Jul. 23, 2007.

(51) Int. Cl. B60K 13/02

(52) U.S. Cl. 180/68.3

(57) ABSTRACT

A system and method for directing airflow through a moving vehicle comprising a fluid intake adapted for receiving a fluid flow, the fluid intake is located generally about a forward portion of the vehicle, at least one fluid duct adapted for containing the fluid flow, the at least one duct extending longitudinally along a portion of the vehicle, and a fluid outlet adapted for exhausting the fluid flow, the fluid outlet located generally about a rearward portion of the vehicle. The system for directing airflow through a moving vehicle, wherein the at least one fluid duct is in communication with the fluid intake and the fluid exhaust for moving fluid within a vehicle.

### CLAIM OF BENEFIT OF FILING DATE

The present application claims the benefit of the filing date of U.S. Patent Application Ser. No. 60/951,306, filed Jul. 23, 2007, the contents of which are hereby expressly incorporated by reference.

### FIELD OF INVENTION

The present invention relates generally to vehicle aerodynamic systems, and more particularly to a vehicle system incorporating ducting for controlling aerodynamic drag characteristics of the vehicle.

### BACKGROUND OF THE INVENTION

A significant cost for operating vehicles arises from the consumption of fuel. The amount of energy required to move such vehicles depends on many factors. For instance, a substantial amount of energy is expended to overcome the resistance encountered in moving the vehicle through a fluid such as air, water, or otherwise. The amount of energy expended depends in a large part on the aerodynamic drag force exerted on the vehicle by the fluid. A vehicle moving through air experiences a drag force, which may be divided into two components: frictional drag and pressure drag. Frictional drag comes from friction generated generally through the boundary layer as the vehicle passes through the air. Pressure drag results from the net pressure forces exerted as the air flows around the vehicle. A substantial component of the pressure drag is associated with the formation of a low-pressure zone behind the vehicle, as evidenced by the formation of a wake behind the vehicle. There continues to be a need in the art for an improved system for managing vehicle drag to improve vehicle performance.

Examples of efforts by others to address vehicle aerodynamics are illustrated in U.S. Pat. No. 5,042,870 (Yura); U.S. Pat. No. 5,584,355 (Burns); U.S. Pat. No. 6,230,832 (von Mayenburg); U.S. Pat. No. 6,230,836 (Cowan); U.S. Pat. No. 6,435,298 (Mizuno); U.S. Pat. No. 6,736,447 (Angelo); U.S. Pat. No. 7,096,986 (Borroni-Bird); U.S. Pat. No. 7,185,944 (Shahbazi), all of which are incorporated by reference for all purposes.

### SUMMARY OF THE INVENTION

The present invention meets the above needs by providing an improved vehicle structure and methods of building vehicles incorporating such structure. By way of summary, the present invention is directed to a system for managing drag of a vehicle having a forward and a rearward portion, such as by reducing, comprising a fluid intake adapted for receiving a fluid flow (e.g., an intake is located generally at a forward portion of the vehicle), at least one fluid duct adapted for containing the fluid flow, the at least one duct extending longitudinally along a portion of the vehicle side, and a fluid outlet adapted for exhausting the fluid flow, the fluid outlet located generally at a rearward portion of the vehicle. In one approach, the intake, duct, and outlet are arranged in a direct and continuous flow path pursuant to which at least a portion of the fluid that enters the intake travels through the duct and exits the outlet, while also bypassing the vehicle cabin. For example, the path of travel of the fluid is directly through the vehicle via the duct (which itself may have a substantially smooth interior wall surface that is free of any baffles or other structure for impeding fluid flow), entering through an inlet of the duct, from the intake, and exiting through the outlet.

In one aspect, the present invention is thus configured to direct airflow through an automotive vehicle rather than deflecting air flow around the automotive vehicle as is typically done. The fluid having traveled through the vehicle may be discharged back to the surround environment at one or more points of a low pressure (e.g., at a pressure below the pressure at the intake), a point at which turbulent fluid is generated by the vehicle (into which turbulent air, the discharged fluid, is re-introduced), at one or more areas in which laminar fluid flow may be observed, or any combination thereof.

In one first aspect the invention is directed to a system for directing airflow through a moving four-wheeled automotive vehicle comprising a fluid intake adapted for receiving a fluid flow, the fluid intake being located generally about a forward portion of the vehicle; at least one fluid duct adapted for containing the fluid flow, the at least one duct extending longitudinally along a bottom portion of the vehicle; and a fluid outlet adapted for exhausting the fluid flow, the fluid outlet located generally about a rearward portion of the vehicle so that the fluid flow is exhausted into a rear wheel well portion of the four-wheeled automotive vehicle;wherein the at least one fluid duct is in communication with the fluid intake and the fluid exhaust for moving fluid within the four-wheeled automotive vehicle. This aspect may be further characterized by one or any combination of the following features: the fluid intake is a vehicle grill, at least one forward wheel well, a hood swoop located within the hood of the vehicle, or combinations thereof; a fluid inlet is located longitudinally behind the rotational axis of a front wheel of the vehicle; the at least one fluid duct is located along at least a portion of a rocker panel of the four-wheeled automotive vehicle; the four-wheeled automotive vehicle includes an underbody plate that is joined to the duct; the air inlet includes an upper wall having an opening therein into which fluid flows from the fluid intake; the air inlet includes an upper wall having a plurality of diagonal openings therein into which fluid flows from the fluid intake; the air inlet includes an upwardly sloping forward wall spaced from the upper wall of the inlet; the air inlet includes an inner flange portion for connecting to the four-wheeled automotive vehicle; the air outlet includes an arcuate inside wall portion; the air outlet includes an opening in an upper wall portion; the air outlet includes an inner flange portion for connecting to the four-wheeled automotive vehicle; the duct has a substantially constant profile along its entire length; the duct is located over below the rotational axis of the front wheels and the rear wheels of the four-wheel automotive vehicle; or the four-wheeled automotive vehicle is powered by an internal combustion engine.

In another, second aspect of the invention, there is contemplated a system for directing airflow through a moving vehicle comprising at least one fluid intake adapted for receiving a fluid flow, the fluid intake is located generally about a forward portion of the vehicle; at least two fluid inlets located downstream of the fluid intake that receive at least a portion of the fluid flow that enters the fluid intake; at least two longitudinally spaced fluid ducts each being connected to a respective one of the fluid inlets, the ducts each extending longitudinally along a bottom portion of the vehicle and being laterally spaced apart from each other; and at least one fluid outlet connected to each fluid duct, the fluid outlet located generally about a rearward portion of the vehicle so that the fluid flow is exhausted into a rear portion of the vehicle. This second aspect of the invention may be further characterized by any one or more of the above features of the first aspect of the invention or any of the following: the vehicle is an automotive vehicle include a pair of front wheels, and a pair of rear wheels, all such wheels having a rotational axis, and the inlets and the ducts are located below the rotational axis of each of the wheels; the air inlet includes an upper wall having an opening therein into which fluid flows from the fluid intake; the air inlet includes an upwardly sloping forward wall spaced from the upper wall of the inlet; the air inlet includes an inner flange portion for connecting to the four-wheeled automotive vehicle; the air outlet includes an arcuate inside wall portion; the air outlet includes an opening in an upper wall portion; the air outlet includes an inner flange portion for connecting to the four-wheeled automotive vehicle; the duct has a substantially constant profile along its entire length.

Yet a third aspect contemplates methods for using systems such as those described above for the first or second aspects of the invention, and thus envisions a method for directing fluid flow within a moving vehicle through a system such as described above for the first or second aspects, or through a method, for example, that comprises the steps of: providing a fluid intake generally located about a forward portion of the vehicle; a fluid outlet generally located about a rearward portion of the vehicle, and at least one fluid duct extending generally longitudinally along at least a bottom portion of the vehicle, the at least one fluid duct having a fluid inlet and a fluid outlet; wherein the at least one fluid duct is in communication with the fluid intake and the fluid outlet; moving the vehicle to introduce a fluid flow within the vehicle through the fluid intake; directing the fluid flow from the fluid intake to a fluid inlet of the at least one fluid duct; containing the fluid flow from the fluid input to the fluid output of the at least one fluid duct; and exhausting the fluid flow from the fluid output through the fluid outlet. This aspect may be further characterized by the employment of any of the structures described in connection with the first or second aspects, or elsewhere herein, and may further be characterized by the features that the vehicle is an automotive vehicle, which is powered by an internal combustion forward located engine, and includes a pair of front wheels, and a pair of rear wheels, each having a rotational axis, the fluid inlet residing behind and below the rotational axes of the front wheels, each of the fluid inlet, the fluid outlet and the duct residing below the rotational axes of the wheels, the directing includes directing air from a compartment located in a forward portion of the vehicle that houses the forward located engine into the fluid inlet behind an below the rotational axes of the front wheels, the containing of the fluid flow occurs along the length of the fluid duct, and the exhausting the fluid flow includes directing the fluid flow toward the rear wheels of the vehicles.

The foregoing aspects may further be characterized by one or any combination of the features taught in the follow detailed description.

### BRIEF DESCRIPTION OF THE DRAWINGS

FIG. 1 is a perspective view of one embodiment of the present invention.

FIG. 2 is a side view of another embodiment of the present invention.

FIG. 3 is a perspective view of components of a system of the present invention.

FIG. 4 is a partial sectional view of a system taken through 4-4 of FIG. 2.

### DETAILED DESCRIPTION OF THE INVENTION

The present invention is predicated upon providing an improved aeroducting feature for a vehicle, and particularly one that channels a fluid through a vehicle. For instance, one preferred approach is to channel a fluid that enters an aeroducting system through a front end of the vehicle, such as through an inlet located at or forward of the rotational axis of the front wheel of a car, and extends substantially along the length of the vehicle (e.g., at least about 50% of the length of the vehicle). Though described herein for a preferred application in a car, it is contemplated that the improved aerodynamic feature may be employed in a variety of vehicles including, without limitation, automotive, aerospace, marine, rail, or the like. The aeroducting feature may be provided in a boat, train, plane, or otherwise, however, is particularly suitable for use in automotive vehicles as discussed herein.

With reference to the drawings, the invention herein contemplates a system for directing airflow through a vehicle 10 (while it is moving) comprising a fluid intake 12 (e.g., an opening which may include one or a plurality of inlets) adapted for receiving a fluid flow, at least one fluid duct 14, and a fluid outlet 16. The fluid intake is adapted for receiving a fluid flow and is located about a generally forward portion of the vehicle (such as forward of the rotational axis RAF). Particularly in the context of the application of the invention to automotive vehicles, one benefit of the invention is that it is possible to make use of vehicle styling without any particular exterior styling modification to allow for specific fluid re-direction. For example, in the ordinary operation of an automotive vehicle, a certain amount of fluid buildup occurs (e.g., in the engine compartment) from air that passes through a vehicle grill. The present invention contemplates the possibility of capturing at least a portion of that air, such as while or subsequent to when the air is in the engine compartment, and re-directing it through the fluid duct 14.

It is also possible to include a particular structure (e.g., one or more exterior styling feature, such as a spoiler, an air scoop, louvers, port holes, any combination thereof, or the like that serves as the fluid intake) that will function as a fluid intake. Other such components of an automotive vehicle that may act as a fluid intake include a grill, a wheel well, a hood swoop, combinations thereof or the like. For an automotive vehicle (or other vehicles), preferably, the fluid intake includes the vehicle front end portion 18 (e.g., including a grill), wherein fluid flow travels to the forward fascia of the vehicle through the vehicle grill and into the engine compartment 20. After the fluid flow enters the vehicle front end portion 18 (e.g., directly through a grill) it may travel through a radiator, wherein the fluid flow may be directed towards the engine, elsewhere, preferably generally rearward), or both. In this manner, it can be appreciated that portions of the fluid flow taken into the vehicle may also provide a basis for heating, cooling, air-conditioning, otherwise, or the like such as cooling the engine, air-conditioning a passenger, or otherwise. However, it is to be realized that the present system may differ from conventional vehicle heating, ventilation, and cooling systems as a result of the ducting, pursuant to which fluid flow may be managed by directing fluid flow generally around the internal cab of the vehicle, thereby substantially bypassing the HVAC.

Furthermore, the fluid flow may provide a cooling effect of the engine compartment or substantially by-pass the engine itself, either being preferably substantially free of combustion. Moreover, the engine compartment and/or substantially the vehicle floor may be generally sealed therebelow, thereby reducing or eliminating fluid flow deflections such as gaps in the undercarriage between components of the vehicle. These gaps increase surface friction along the undercarriage of the vehicle, which diverts fluid flow thereby causing turbulent fluid flow that creates vehicle drag. By generally sealing the undercarriage of at least the engine compartment, preferably substantially the entire undercarriage, surface friction along the undercarriage may be decreased to improve the aerodynamics of the vehicle and reduce vehicle drag, thereby improving vehicle performance and gas mileage.

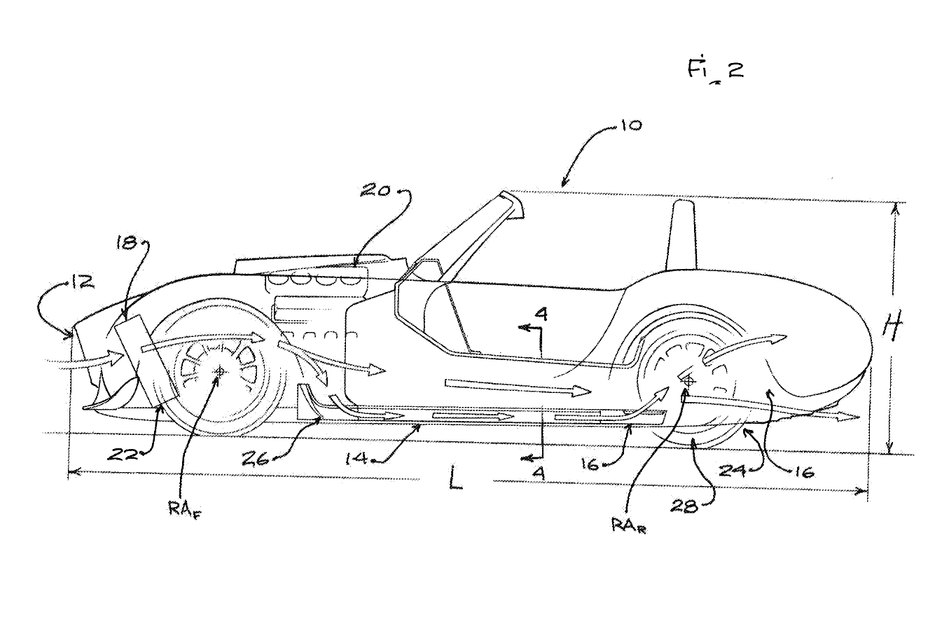

Once the fluid flow enters the vehicle from a forward located opening (e.g., a grill or other suitable opening) the fluid may immediately be directed into at least one fluid duct 14; it may be directed through the engine compartment, during or after which it is directed into at least one fluid duct 14; or a combination of both. Preferably, there are two fluid ducts, each located longitudinally along a side of the vehicle. However it is appreciated that the at least one fluid duct may longitudinally extend, such as along a generally central portion of the vehicle. The fluid duct is adapted for containing the fluid flow through at least a portion of the vehicle side. Preferably, the fluid duct extends generally between the forward and rearward wheel wells 22 and 24, respectively. The fluid duct includes a fluid input that is adapted for receiving the fluid flow from the fluid intake. As the air is travel from the air intake, it is directed through a fluid inlet 26 and into the fluid duct 14. The fluid inlet may include a vented structure, such as one or more vents located about a generally forward portion of the fluid duct. It is contemplated that a fluid duct may be defined by at least a portion of any hollow component of the vehicle, such as a rocker panel, a fender, a door, a quarter panel, a headliner, a pillar, a drive line tunnel, the like, or combinations thereof. As seen in FIG. 2, air flow is possible through one or more ducts on one or both sides of the vehicle.

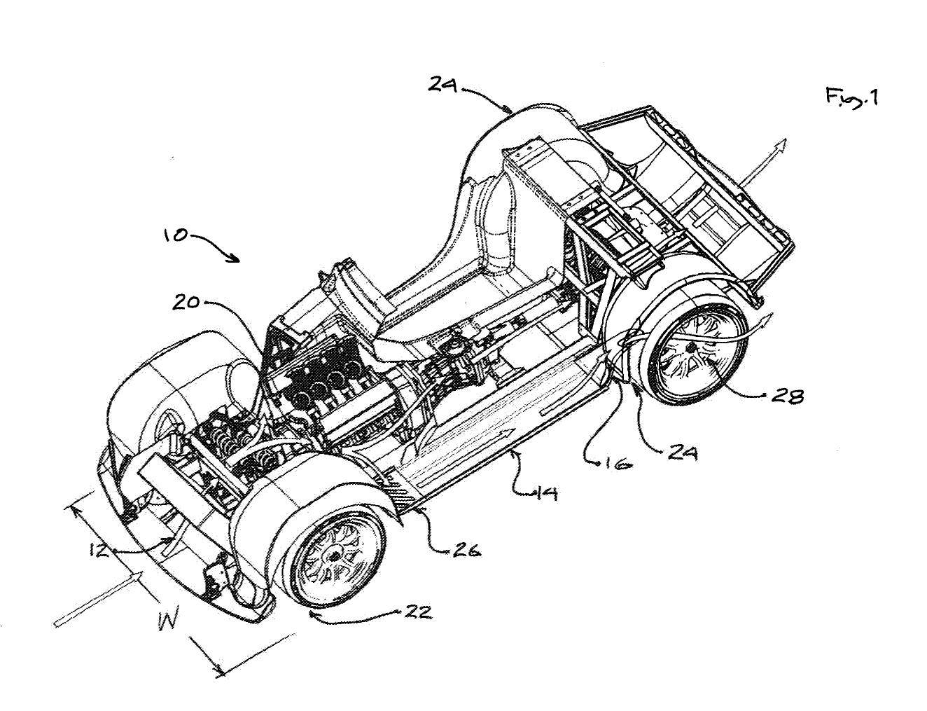

The fluid duct may have the inlet 26 at a forward end of the duct, which extends to the front intake, it may be longitudinally spaced from the front intake or a combination. For example, as shown in the drawings of FIGS. 1 and 2, fluid that passes through the duct may be air that builds up in the engine compartment. The ducting thereby assists to manage the removal of that air without contributing to aerodynamic drag.

The fluid duct further includes a fluid outlet 16 that is adapted for exhausting the fluid flow from the fluid duct. The fluid outlet is generally located about a rearward portion of the fluid duct. The fluid outlet may include a vent that directs fluid flow. The fluid outlet may be located about a generally rearward portion of the vehicle and may be adapted for exhausting the fluid flow into the environment externally of the vehicle. For example, as shown, the outlet 16 may be located forward of (and either above and/or below) the rear rotational axes (RAR) of the vehicle. The outlet 16 may be configured for directing fluid flow upwardly and outwardly relative to a rotating wheel 28 (see, e.g., FIG. 2). More specifically, for a car it is preferred that the fluid outlet is located about a portion of the rearward wheel well and preferably directs fluid flow therein to be exhausted into the environment.

For example, the fluid flow may be directed through ducting contained within of defined by space within the framework and/or bodywork of the vehicle through a specifically configured duct that is adapted as its main purpose to channel fluids (e.g., it is not relied upon to structurally support the vehicle frame or body), or through some other concealed structure. The fluid duct thus may be integrated within or a part of a hollow component of a vehicle structure during the manufacturing of the hollow component, it may be the hollow component itself, it may be installed within the hollow component after the vehicle is manufactured or a combination thereof. For example, in one embodiment, the fluid duct is incorporated, at least in part, through the existing framework of the vehicle such as a hollow rocker panel. The rocker panels extend longitudinally along the sides of the vehicle and are positioned generally along the bottom portion of the vehicle sides. The fluid duct thus may be formed by the process of stamping, roll-forming hydroforming, blow-molding, hot-forming, cold-forming, injection molding, extrusion, otherwise, or combinations thereof. The fluid duct may include a liner that is disposed in a hollow cavity, such as in a channel of a vehicle frame, a hydroformed tube, or the like.

As previously mentioned, the fluid duct may be at least a portion of a hollow component, wherein the cross-section of the hollow component provides a generally unobstructed path for fluid flow. Advantageously, the profile of the fluid duct may be tuned with respect to each specific vehicle type for achieving a desired flow path, reducing aerodynamic drag, improving vehicle performance, or otherwise. As such, along the length of the duct, it is appreciated the fluid duct may have a constant cross-section or a variable cross-section, wherein the variable cross-section may constrict, expand, or otherwise and combinations thereof. The fluid duct may have a constant diameter section along at least a portion of its length (e.g., over at least half of its length, and more preferably at least three-quarters of its length). In another aspect, the fluid duct cross-section may constrict, expand, or both constrict and expand, respectively, thereby generally increasing or decreasing the fluid flow pressure through the fluid duct. Furthermore, it is contemplated that the fluid duct may include obstructions such as baffles, attachment means, filters, valves, meters, the like or otherwise. The fluid duct may be generally obstruction free and has generally no constrictions. For a car, the duct may have a rearward disposed portion that has a contoured outer wall that is substantially the geometry of the wheel well of the car. That is the duct includes a curved fluid flow path in the region proximate the outlet that winds around the curvature of a wheel well. The generally curved fluid flow pattern herein unexpectedly helps to achieve the desire result of reduced drag.

In view of the forgoing, it is appreciated that fluid inlet and outlet and the fluid duct fluid input and output may vary in size and shape, wherein the geometry of each may be dependent on the design of the vehicle and specific performance needs thereof. Preferably, the fluid inlet that is positioned about the forward portion of the vehicle has a generally large cross-section to direct large amounts of fluid into the ducting system, more specifically, into the fluid input of the fluid duct. As discussed herein, it may be desirable to increase or decrease the fluid flow pressure through the system, which may be accomplished by varying the sizes of the fluid inlet and outlet and the fluid duct fluid input and output.

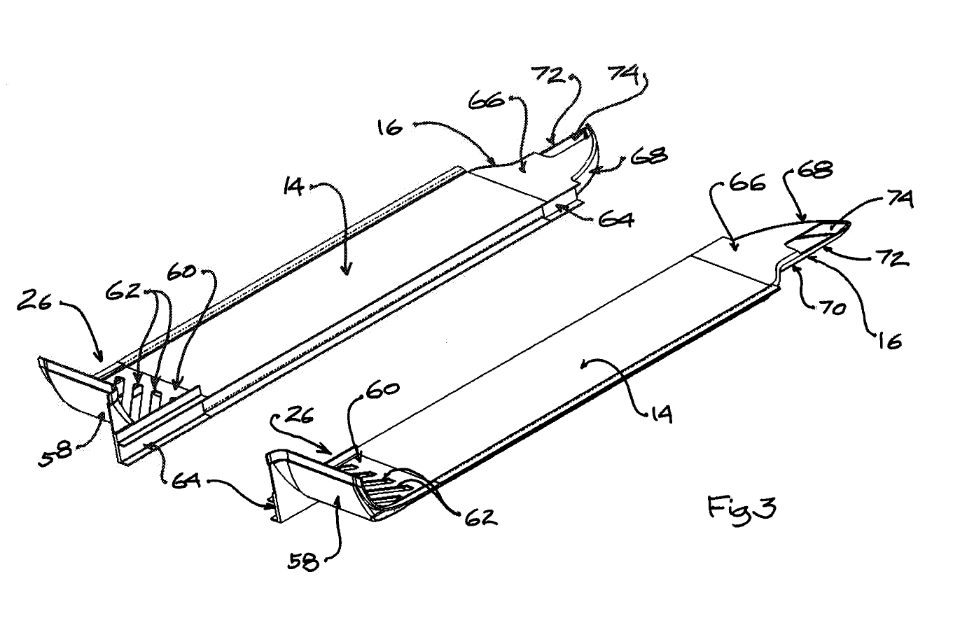

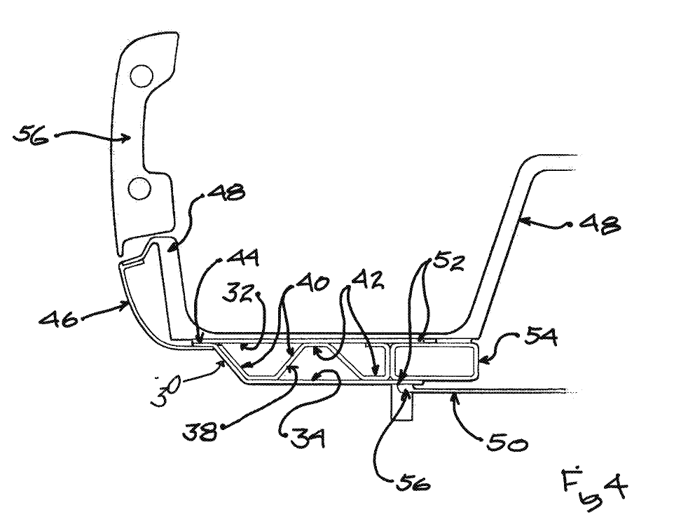

With reference to FIGS. 3 and 4, there is shown an example of one approach to design of a system in accordance with the present invention. Duct 14 extends generally longitudinally. Along a majority of its length (e.g., at least 50%, more preferably at least 70%) the duct has a substantially constant cross section (shown in FIG. 3 as an intermediate portion). The duct has at least one outer wall 30 (e.g., which may have a double wall structure), upper wall 32, lower wall 34, and inner wall 36. Additional intermediate walls may be included as well. For example, as seen in FIG. 4, there may be an insert 38 that is formed to include a plurality of walls that span between the upper wall 32 and the lower wall 34. The insert may have one or more sloping (and/or vertical) walls 40 adjoining one or more horizontal walls 42. The insert may overlap a portion of the outer, upper, lower, and/or inner walls to provide a double wall structure, such as for reinforcement. The insert may be extruded, pultruded, roll-formed, or otherwise fabricated to define an appropriate structure. The insert may be joined to the vehicle (or duct) mechanically, adhesively or both. The duct may have one or more flange portions 44.

The duct may be attached to the vehicle in a suitable manner (e.g., mechanically, adhesively or both). For example, an outer flange portion 44 may be disposed (e.g., in sealing relationship) between a rocker 46 and one or more components (e.g., drive train tunnel 48) of the vehicle frame or body-in-white. An underbody plate 50, such as a belly pan or underwing component, may be joined to an opposing end relative to the flange portion. The duct may thus include an inner flange portion 52 that adjoins a tubular structure 54, such as a vehicle frame rail. The underbody plate may thus have side edge 56 that adjoins the inner flange portion 52. One or more vehicle doors 56 may be above the rocker panel 46, such as for at least about 70% the length of the duct, more preferably at least about 85% the length of the duct, and still more preferably, substantially the entire length of the duct.

The fluid flow through the fluid intake and/or the fluid outlet may be directed over, through, around, or otherwise the forward wheel well, the rearward wheel well, or both the forward and rearward wheel wells. To illustrate, FIG. 3 shows a possible approach to configuring an inlet 26 and outlet 16 for the duct 14. The inlet has a forward upwardly sloping wall 58 (such as a wall that adjoins or at least partially defines a portion of a forward wheel well), an upper wall 60 that has one or more openings 62 (e.g., the diagonally slotted openings as shown in the drawing, which may be angled forwardly inward as shown) through which intake fluid flows. The inlet may include an inner flange portion 64, which longitudinally aligns with the inner flange portion 52 of the duct. Preferably a space is defined between the forward upwardly sloping wall 58 and the upper wall 60 for fluid flow. The inlet 26 may be configured for forming a suitable joint with the duct. For example, the inlet the duct or both may include a lip, a tongue or other suitable projection for forming a suitable male/female mating joint. A scarf joint may be employed. One or more mechanical interlocks (e.g., snap-fit) may join the inlet with the duct.

The outlet 16 may also include an inner flange portion 64 (which, like other such structures, may be used to fit the duct with an adjoining vehicle frame member) that longitudinally aligns with the inner flange portion 52 of the duct. The outlet preferably include an upper wall portion 66, an inside wall portion 68 (which may preferably be arcuate), a lower wall portion 70, and an outside wall portion 72 (e.g., a substantially straight portion). One or more openings 74 are formed (e.g., in the upper wall, the lower wall, the outside wall portion or any combination thereof. Fluid that enters the openings 62 of the inlets can exhaust through the outlet openings 74. For each duct assembly, the total area of the openings 62 relative to the total area of the outlet opening 74 may be kept within about 10% of each other. It is possible that it may be approximately the same. It is possible that the area of total area of the openings 62 relative to the total area of the outlet opening 74 will have a ratio of about 0.1:1 to 10:1, and more preferably about 0.3:1 to about 3:1. For example, it is possible that the outlet openings will be smaller than the total area of the inlet openings, thereby affording an increase in the speed of the fluid as it exits the outlet. Of course, some applications may require an opposite effect. Thus, it is possible that the inlet openings will be smaller than the total are of the outlet openings. One preferred approach is such that the total area of the inlet openings is smaller than the area of the outlet openings, e.g., by no more than about 35%, more preferably at least no more than 20%, and still more preferably no more than about 10%.

The ratio of the area of the inlet openings to the average cross-sectional area of the duct along its length may be within about 60% of each other. Preferably the area of the inlet openings is greater than the average cross-sectional area of the duct (the cross-sectional area of the duct being measured across a section, such as depicted in FIG. 4). For example, the ratio of the area of the inlet openings to the average cross-sectional area of the duct along its length is from about 1.1:1 to about 2:1, and more preferably about 1.5:1.

The ratio of the area of the outlet opening to the average cross-sectional area of the duct along its length may be within about two times each other. Preferably the area of the outlet opening is greater than the average cross-sectional area of the duct. For example, the ratio of the area of the outlet opening to the average cross-sectional area of the duct along its length is from about 1.1:1 to about 3:1, and more preferably from about 1.5:1 to about 2:1.

It can be seen that under conditions described above, the rate of fluid flow in the duct can be increased relative to its rate upon entering (e.g., experiencing a venture-effect. Avoidance of cavitation at the outlet also may occur. In an automotive vehicle, upon exhaust, the flow of the fluid is such that rotational motion of the rear wheels may assist to draw air from outlets, such as by reducing pressure in the region.

Upper walls of the inlet, duct and/or outlet may be generally flat and substantially horizontally aligned. The inner flange portions of each of the inlet, outlet and/or duct may be employed in contact with (directly or indirectly), the vehicle frame structure (e.g., with a longitudinal frame rail). The duct may be closed about its periphery for its entire length with openings only where it connects to the inlet and the outlet. The inlet, the outlet or both may be separately made and attached to the duct. The inlet, the outlet or both may be integrally made as a single component so that separate attachment is unnecessary.

Advantageously, by directing fluid flow through the wheel wells, it is appreciated that additional cooling of the vehicle brakes may be provided. Furthermore, the fluid flow through the fluid intake and the fluid outlet may be generally elevated with respect with the air flow through the fluid duct, which is generally positioned along the bottom portion of the vehicle, preferably, the duct extends adjacent to at least a portion of the vehicle's underside. As such, it is appreciated that the overall fluid flow through the vehicle may be generally representative of a curved (e.g., generally sinusoidal) flow path. However, it is appreciated that the fluid flow through the system may flow through a generally linear path. It is contemplated, that the fluid flow path directed towards the rear portion of the vehicle is preferably directed towards the underside of the rear portion of the vehicle, as discussed herein, such that the fluid flow path is not directed towards or exhausted from the rear bumper of the vehicle.

In another aspect, the fluid flow may be generally directed into a high-pressure area, such as the engine compartment and is thereafter drawn through the fluid duct towards a low-pressure area such as the rearward wheel well. This transition from a high pressure and/or normal pressure level to the lower pressure area helps reduce and or eliminate vehicle lift. Furthermore, by exhausting fluid flow to a generally low-pressure area, fluid flow drawn through the fluid intake may increase. Thus the fluid having traveled through the vehicle may be discharged back to the surrounding environment at one or more points of a low pressure (e.g., at a pressure below the pressure at the intake), a point at which turbulent fluid is generated by the vehicle (into which turbulent air, the discharged fluid, is re-introduced), at one or more areas in which laminar fluid flow is observed, or any combination thereof.

As previously mentioned, one or more portions of the underside of the vehicle may be sealed, such as the engine compartment. For example, the underbody plate 50 may be disposed beneath the engine, beneath the floor pan of the vehicle, or both. The entire underside of the vehicle may likewise be sealed or enclosed. By enclosing portions of or the entire underside of the vehicle, improvements may be made to the efficiency of the vehicle such as reducing drag, improving vehicle gas/mileage consumption, improving vehicle performance and/or drivability, otherwise, or combinations thereof. For example, in one embodiment, enclosing the underside of an automotive vehicle may be used for aerodynamic streamlining (e.g., for increasing down force over the front vehicle wheels) and/or to plane over off-road debris such as grass, rocks, the like, or otherwise.

If the underside of the vehicle is enclosed, it may be possible to reduce the aerodynamic drag caused by the exposed hardware like the suspension, the oil pan, the exhaust system, or otherwise. However, this may result in a rise of temperature in the engine compartment, and possibly overheating of the cooling system for the vehicle, more specifically, the engine, because the normal fluid flow path through the bottom of the vehicle has been eliminated or enclosed. To achieve a cooling effect within the vehicle, the fluid flow through the engine compartment (and the radiator) may be managed by ducting/directing the fluid flow to a low-pressure area that would be suitable to help evacuate/draw the fluid through the vehicle, thereby restoring the cooling capacity lost by enclosing the vehicle. Management of the fluid flow within the engine compartment can be done by selection of the location of the duct inlet (e.g., preferably toward the bottom of the vehicle, such as below and behind the rotational axis of the front wheels of a car). It is contemplated that the present invention may further include a forced fluid component having fans, compressors, blowers, otherwise, or combinations thereof, adapted for use to further enhance the evacuation of the fluid flow through the system to create lift, to enhance the ventilation system, or otherwise.

The ability to route air that builds up in the engine compartment of an automotive vehicle through the vehicle also provides a surprising benefit in that the bottom of the vehicle can be enclosed (e.g., the bottom of the engine compartment can be closed, such as with a suitable underbody plate such as a belly pan or underwing component), thereby allowing an increase in down force (e.g., by at least 10%, more preferably by at least 30%) that can be generated over the front wheels as compared with a similar vehicle without any underbody plate. Thus, air from the air intake can be used for cooling the engine and then be routed through the vehicle for exhausting toward the rear of the vehicle (e.g., into a wheel well, where the air also is directed at the wheels for cooling the brakes).

The vehicle may be a boat, wherein the fluid intake is generally located about the deck. The fluid flow enters the fluid intake and is directed towards the fluid duct. The fluid duct generally extends longitudinally along the hull of the boat, preferably generally below the water line. The fluid duct preferably extends generally along a side of the boat hull, however it is appreciated the fluid duct may extend generally along the center of the boat. Upon entering the fluid intake and traveling through the fluid duct via the fluid input and fluid output, the fluid flow is directed towards the fluid outlet. The fluid outlet may be generally located below the water line above the water line or both to exhaust the fluid flow. In one aspect wherein the fluid flow is exhausted below the water line, the fluid flow is introduced along the bottom of the boat thereby reducing water drag. Advantageously, by reducing water drag, the boat reduces gas consumption, improves performance, the like, or otherwise. One embodiment of the present invention may be directed to a single fluid duct: however it is appreciated the vehicle may include one or more fluid ducts, preferably two.

Other variations of the invention are also possible. For example, it may be possible to carry a catalyst within the duct, thereby facilitating a catalytic reaction within the fluid to provide an environmental feature for the vehicle. For example, in accordance with the teachings of U.S. Pat. No. 6,699,529, incorporated by reference, an ozone depleting catalyst may be employed. As such, the fluid duct may further include a catalyst coating that is preferably located along the interior surface of fluid duct. As the fluid flow enters the fluid duct and begins to react with the catalyst coating, the fluid flow or portions thereof become purified. Thereafter, the purified fluid flow is exhausted into the environment.

In another example, a turbine may be incorporated within the duct for changing pressure within the duct. A turbine may be incorporated within the duct for generating electricity. The ducts herein may be formed as part of an underbody protector plate that spans a portion or substantially the entirety of the length of the vehicle, the width of the vehicle, or both.

In another example, a filter, a check valve, the like, and/or otherwise may be included within the system. These components may be incorporated to provide information directed to the fluid flow. This information may help identify the rate of the fluid flow, what components make up the fluid flowing through the system, eliminate components of the fluid flow, or otherwise. For example, if the fluid flowing through the system is preferably air, a check valve may be incorported to reduce water entering the system.

In yet another example, the fluid duct itself may be formed of a material that has a low surface friction, e.g., polyolefinic such as PTFE, the like, or otherwise or may include as an internal surface coating having a nanotexture for resisting the build-up of debris or otherwise.

By way of further summary, the teachings herein contemplate a system for directing airflow through a moving vehicle comprising: a fluid intake adapted for receiving a fluid flow, the fluid intake is located generally about a forward portion of the vehicle; at least one fluid duct adapted for containing the fluid flow, the at least one duct extending longitudinally along a portion of the vehicle; and a fluid outlet adapted for exhausting the fluid flow, the fluid outlet located generally about a rearward portion of the vehicle; wherein the at least one fluid duct is in communication with the fluid intake and the fluid exhaust for moving fluid within a vehicle. The systems described herein may be further characterized by one or any combination of the following features: the fluid intake is a vehicle grill, at least one forward wheel well, a hood swoop located within the hood of the vehicle, or combinations thereof the fluid flows through the vehicle grill to an engine compartment; the fluid flows through a radiator to cool the engine compartment; the engine compartment is a generally high-pressure area; the fluid flow from the fluid intake is directed into the at least one fluid duct; the fluid flow from the engine compartment is directed into the at least one fluid duct; the fluid flow from the radiator is directed into the at least one fluid duct; the at least one fluid duct includes a fluid input, the fluid input is adapted for receiving the fluid flow from the fluid intake; the fluid input is located about a generally forward portion of the at least one fluid duct; the fluid input is a vent; fluid flow from the fluid intake is directed into the fluid input; fluid flow from the vehicle grill, the at least one forward wheel well, the hood swoop, or combinations thereof are directed into the fluid input; at least one fluid duct is located rearward of the at least one forward wheel well; at least one fluid duct is at least a potion of a rocker panel, a fender, a door, a quarter panel, a headliner, a pillar, a drive line tunnel, or combinations thereof; at least one fluid duct is generally located along the side of the vehicle; at least one fluid duct is generally located along the center of the vehicle; at least one duct extends generally along at least a middle portion of the vehicle side; at least one fluid duct further includes a fluid output, the fluid output being adapted for exhausting the fluid flow; the fluid output is located about a generally rearward portion of the at least one fluid duct; the fluid output is a vent; the fluid output directs fluid flow to the fluid outlet; the fluid outlet is located about a portion of at least one rearward wheel well; the fluid flow is exhausted through the fluid outlet to a generally low-pressure area; exhausting fluid flow to a generally low pressure area increases the fluid flow drawn through the fluid intake; at least one fluid duct includes a catalyst coating (e.g., so that the fluid flow entering the at least one fluid duct reacts with the catalyst coating to purify at least a portion of the fluid flow, which may be exhausted to the environment; the underside of the vehicle is generally enclosed; the generally enclosed underside of a vehicle reduces vehicle drag, improves vehicle mileage consumption, improves vehicle performance, or combinations thereof; the vehicle is an automobile, a boat, a plane, or a train; the fluid intake is located on the deck of a boat; the at least one fluid duct generally extends along the sides of a hull of a boat; at least one fluid duct extends below the water line of a boat; the fluid outlet is located below the water line, above the water line, or both, of a boat; the fluid flow is exhausted below the water line to introduce air along the bottom of a boat thereby reducing water drag; the system further includes a forced fluid component (e.g., a compressor, blower, fan, or combinations thereof) adapted for pushing, drawing, or both fluid through the system thereby creating lift to enhance ventilation of the system.

The teachings herein also contemplate methods of using any of the systems described herein, and generally will include providing a fluid intake generally located about a forward portion of the vehicle; a fluid outlet generally located about a rearward portion of the vehicle, and at least one fluid duct extending generally longitudinally along at least a portion of the vehicle, the at least one fluid duct having a fluid input and a fluid output; wherein the at least one fluid duct is in communication with the fluid intake and the fluid outlet; moving the vehicle to introduce a fluid flow within the vehicle through the fluid intake; directing the fluid flow from the fluid intake to the fluid input of the at least one fluid duct; containing the fluid flow from the fluid input to the fluid output of the at least one fluid duct; and exhausting the fluid flow from the fluid output through the fluid outlet.

The invention herein (including any of the above described systems or methods) may further be characterized by one or any combination of the following features: the fluid duct is free of any turbine; flow of fluid through the fluid duct encounters no resistance from any turbine (e.g., a turbine powered by the fluid, a turbine powered by a motor, such as a fan or blower, or a combination) other than a vehicle wheel; the vehicle employing the fluid duct of the present invention is powered by an internal combustion engine; ratio of the height of the vehicle at its tallest point to the length of the vehicle at its longest point is greater than about 2:1 (e.g., greater than about 2.5:1, or even greater than about 3:1); the vehicle has a ratio of width to height to length of about 2:1:4 (e.g., the vehicle has a width of about 1.8 meters (m), a height of about 1.2 m, and a length of about 3.9 m) the vehicle employs only four wheel and tire sets; fluid flow through the fluid duct exits through a region proximate the rear wheel of the vehicle; a majority of the length of the fluid duct is located below the rotational axis of both the front wheels and the rear wheels of the vehicle; the fluid duct spans at least 60% of the length of the vehicle; the fluid duct spans at least 60% of the length of the vehicle and any fluid intake inlet it has is located forward of the vehicle front wheels; the fluid duct includes a pair of spaced apart ducts that have a total sectional width (for a section located between the front wheels and the rear wheels) that is less than about one half of the width of the vehicle at such location; the vehicle is free of fins on a rear underbody cover; any fluid intake inlet of the fluid duct is located forward of the front wheel of the vehicle; a fluid intake inlet is disposed substantially coincidentally with the longitudinal centerline of the vehicle (e.g., the vehicle employs only a single fluid intake inlet that is disposed substantially coincidentally with the longitudinal centerline of the vehicle); the engine compartment of the vehicle is located forward of the passenger compartment; fluid flow through the ducts is directs air outwardly from the sides of the vehicle (e.g., at the rear wheels); airflow through the engine compartment of the vehicle is realized directly from a fluid intake inlet (e.g., a front grill of the vehicle, an air scoop, or both); fluid that exits any fluid duct through the rear of the vehicle is fluid that entered the vehicle forward of the front vehicle wheels; the fluid ducts are generally concealed from view (except perhaps from underneath the vehicle) in the vehicle over at least 90% of the length of the fluid duct; the vehicle is a car (e.g., a sports car or other car having a drag coefficient that is below 0.35 (e.g., below about 0.3); fluid that enters any fluid intake inlet is bypassed and prevented from entering the passenger compartment of the vehicle (either directly or indirectly, such as by way of an HVAC unit); or any combination of the foregoing.

Though dimensions may be varied it is preferable that the length of that fluid needs to travel upon entering an inlet opening until it exists the outlet is about 1.5 to about 2.5 m (e.g., about 2 m). The duct will comprise about 45 to about 75% of that length (e.g., the duct will be about 0.7 to about 2 m in length, and more preferably about 1.2 m). The length of each of the inlet and the outlet is about the same (e.g., about 0.2 to about 0.6 m, more preferably about 0.4 m). Thus it is possible that a constant cross-sectional area of the duct will extend about 45 to about 75% the length of the assembly of the duct, inlet and outlet. The constant cross-sectional area may be located between the RAF and RAR and may be about 40 to about 60% of the vehicle wheelbase distance that spans the RAF and RAR. For example, a vehicle may have a wheelbase of about 2.3 m (e.g., 2.301 m and the length of the assembly of about 2 m (e.g., 1.951 m). By way of example and without limitation an average cross-sectional area of the duct may range from about 90 to about 150 square centimeters (e.g., about 123 square centimeters). This cross-sectional area may be substantially constant along some or all of the length of the duct as discussed above. The duct is wider than it is high (e.g., the overall width (upper wall and/or lower wall) is at least two times the height, and more preferably at least about 4 times the height). Overall, the ducts may span a total width of the vehicle less than about one half of the vehicle (e.g., between about 35 and 45% of the vehicle width).

It will be further appreciated that functions or structures of a plurality of components or steps may be combined into a single component or step, or the functions or structures of one-step or component may be split among plural steps or components. The present invention contemplates all of these combinations. Unless stated otherwise, dimensions and geometries of the various structures depicted herein are not intended to be restrictive of the invention, and other dimensions or geometries are possible. Plural structural components or steps can be provided by a single integrated structure or step. Alternatively, a single integrated structure or step might be divided into separate plural components or steps. In addition, while a feature of the present invention may have been described in the context of only one of the illustrated embodiments, such feature may be combined with one or more other features of other embodiments, for any given application. It will also be appreciated from the above that the fabrication of the unique structures herein and the operation thereof also constitute methods in accordance with the present invention. The present invention also encompasses intermediate and end products resulting from the practice of the methods herein. The use of “comprising” or “including” also contemplates embodiments that “consist essentially of” or “consist of” the recited feature.

The explanations and illustrations presented herein are intended to acquaint others skilled in the art with the invention, its principles, and its practical application. Those skilled in the art may adapt and apply the invention in its numerous forms, as may be best suited to the requirements of a particular use. Accordingly, the specific embodiments of the present invention as set forth are not intended as being exhaustive or limiting of the invention. The scope of the invention should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes.

1. A system for directing airflow through a moving four-wheeled automotive vehicle comprising:
a fluid intake adapted for receiving a fluid flow, the fluid intake is located generally about a forward portion of the vehicle;
at least one fluid duct adapted for containing the fluid flow, the at least one duct extending longitudinally along a bottom portion of the vehicle; and
a fluid outlet adapted for exhausting the fluid flow, the fluid outlet located generally about a rearward portion of the vehicle so that the fluid flow is exhausted into a rear wheel well portion of the four-wheeled automotive vehicle;
wherein the at least one fluid duct is in communication with the fluid intake and the fluid exhaust for moving fluid within the four-wheeled automotive vehicle.

2. The system of claim 1, wherein the fluid intake is a vehicle grill, at least one forward wheel well, a hood swoop located within the hood of the vehicle, or combinations thereof.

3. The system of claim 2, wherein a fluid inlet is located longitudinally behind the rotational axis of a front wheel of the vehicle.

4. The system of claim 3, wherein the at least one fluid duct is located along at least a portion of a rocker panel of the four-wheeled automotive vehicle.

5. The system of claim 4, wherein the four-wheeled automotive vehicle includes an underbody plate that is joined to the duct.

6. The system of claim 3, wherein the air inlet includes an upper wall having an opening therein into which fluid flows from the fluid intake.

7. The system of claim 6, wherein the air inlet includes an upper wall having a plurality of diagonal openings therein into which fluid flows from the fluid intake.

8. The system of claim 7, wherein the air inlet includes an upwardly sloping forward wall spaced from the upper wall of the inlet.

9. The system of claim 8, wherein the air inlet includes an inner flange portion for connecting to the four-wheeled automotive vehicle.

10. The system of claim 3, wherein the air outlet includes an arcuate inside wall portion.

11. The system of claim 10, wherein the air outlet includes an opening in an upper wall portion.

12. The system of any of the claim 1, wherein the air outlet includes an inner flange portion for connecting to the four-wheeled automotive vehicle.

13. The system of claim 10, wherein the duct has a substantially constant profile along its entire length.

14. The system of claim 13, wherein the duct is located over below the rotational axis of the front wheels and the rear wheels of the four-wheel automotive vehicle.

15. The system of claim 14, wherein the four-wheeled automotive vehicle is powered by an internal combustion engine.

16. A system for directing airflow through a moving vehicle comprising:
at least one fluid intake adapted for receiving a fluid flow, the fluid intake is located generally about a forward portion of the vehicle;
at least two fluid inlets located downstream of the fluid intake that receives at least a portion of the fluid flow that enters the fluid intake;
at least two longitudinally spaced fluid duct each being connected to a respective one of the fluid inlets, the ducts each extending longitudinally along a bottom portion of the vehicle and being laterally spaced apart from each other; and
at least one fluid outlet connected to each fluid duct, the fluid outlet located generally about a rearward portion of the vehicle so that the fluid flow is exhausted into a rear portion of the vehicle.

17. The system of claim 16, wherein the vehicle is an automotive vehicle include a pair of front wheels, and a pair of rear wheels, all such wheels having a rotational axis, and the inlets and the ducts are located below the rotational axis of each of the wheels.

18. The system of claim 17, wherein the air inlet includes an upper wall having an opening therein into which fluid flows from the fluid intake; the air inlet includes an upwardly sloping forward wall spaced from the upper wall of the inlet; the air inlet includes an inner flange portion for connecting to the four-wheeled automotive vehicle; wherein the air outlet includes an arcuate inside wall portion; the air outlet includes an opening in an upper wall portion; the air outlet includes an inner flange portion for connecting to the four-wheeled automotive vehicle; the duct has a substantially constant profile along its entire length.

19. A method for directing fluid flow within a moving vehicle comprising the steps of:
providing a fluid intake generally located about a forward portion of the vehicle; a fluid outlet generally located about a rearward portion of the vehicle, and at least one fluid duct extending generally longitudinally along at least a bottom portion of the vehicle, the at least one fluid duct having a fluid inlet and a fluid outlet; wherein the at least one fluid duct is in communication with the fluid intake and the fluid outlet;
moving the vehicle to introduce a fluid flow within the vehicle through the fluid intake;
directing the fluid flow from the fluid intake to a fluid inlet of the at least one fluid duct;
containing the fluid flow from the fluid input to the fluid output of the at least one fluid duct;
exhausting the fluid flow from the fluid output through the fluid outlet.

20. The method of claim 19, wherein the vehicle is an automotive vehicle, which is powered by an internal combustion forward located engine, and includes a pair of front wheels, and a pair of rear wheels, each having a rotational axis, the fluid inlet residing behind and below the rotational axes of the front wheels, each of the fluid inlet, the fluid outlet and the duct residing below the rotational axes of the wheels, the directing includes directing air from a compartment located in a forward portion of the vehicle that houses the forward located engine into the fluid inlet behind an below the rotational axes of the front wheels, the containing of the fluid flow occurs along the length of the fluid duct, and the exhausting the fluid flow includes directing the fluid flow toward the rear wheels of the vehicles.
